(19) United States
(12) Patent Application Publication
(10) Pub. No.: US 2025/0253425 A1
(43) Pub. Date: Aug. 7, 2025

(54) IMPROVED LITHIUM BATTERIES RECYCLING PROCESS

(71) Applicant: TECHNOLOGIES LITHION INC., Anjou (CA)

(72) Inventors: Bruno BACON, Montreal (CA); Mathieu CHARBONNEAU, Montreal (CA); Hubert DUMONT, Beaconsfield (CA); Frédéric BITON, Saint-Bruno-de-Montarville (CA); Christian NORMAND, Saint-Basile-le-Grand (CA); Vital FERLAND, Saint-Mathieu de Beloeil (CA)

(21) Appl. No.: 18/857,703

(22) PCT Filed: May 2, 2023
(86) PCT No.: PCT/CA2023/050591

§ 371 Date: Oct. 17, 2024

Related U.S. Application Data
(60) Provisional application No. 63/364,004, filed on May 2, 2022.

(51) Int. Cl. H01M 10/54; C22B 1/24; C22B 3/26; C22B 7/00; C22B 26/12

(52) U.S. Cl. CPC H01M 10/54; C22B 1/24; C22B 3/26; C22B 7/005; C22B 7/007; C22B 26/12

(57) ABSTRACT

The present relates to a process of shredding a lithium battery. The lithium battery is shredded and quenched with a shredding liquid in a shredding compartment to safely discharge the batteries and producing shredded battery residues and a liquid comprising organic compounds and lithium compound. At least a portion of the liquid is separated from the shredded battery residues to obtain a separated liquid containing a low flash point solvent and a high flashpoint solvent. A recycled shredding liquid is produced from the separated liquid by removing at least a portion of the low flash point solvent and/or increasing the concentration of the high flashpoint solvent in the recycled shredding liquid to increase a flash point of the recycled shredding liquid compared to the shredding liquid in the shredding compartment. The recycled shredding liquid is fed to the shredding compartment to replace at least a portion of the shredding liquid.

### CROSS-REFERENCE TO RELATED APPLICATION

The present application is claiming priority from U.S. Provisional Application No. 63/364,004 filed May 2, 2022, the content of which is hereby incorporated by reference in its entirety.

### TECHNICAL FIELD

This disclosure relates generally to a process for recycling lithium batteries and a black mass obtained from same.

### BACKGROUND

The prevalence of lithium batteries has increased as the world attempts to shift away from hydrocarbon based energy. There are a wide variety of lithium batteries available in the market, with the majority falling within these types: LFP (lithium iron phosphate), LCO (lithium cobalt oxide), LMO (lithium manganese oxide), NMC (lithium nickel manganese cobalt oxide), NCA (lithium nickel cobalt aluminium oxide), NCMA (nickel-cobalt-manganese-aluminum) and LTO (lithium titanate). The names describe the active material in each of the different lithium battery type. In the automotive industry in particular, the use of lithium batteries is on the rise. Electric vehicles are projected to gain an increasing part of the automotive market. However, most lithium batteries are recycled in a way that has a significant environmental impact and fails to recover many valuable materials. Supply of materials used for the manufacturing of lithium batteries, such as lithium, nickel and cobalt, are projected to be at risk in the near future and alternative sources of those materials must be used to ensure an affordable cost for lithium batteries. Recycling of batteries at the end of their life and of production off-spec materials used in the manufacturing of lithium batteries will play an important role in reducing the scarcity of these critical materials. Recycling is also necessary to obtain a positive environmental impact for the use of electric cars, as the raw materials exploitation of the batteries components have a large environmental burden.

In WO2019060996 an innovative lithium recycling process was described in which lithium batteries are shredded and the residues are immersed in an organic solvent. This process advantageously allows the shredding of lithium batteries without a prior step of discharging the batteries. Moreover, this process can handle all cathode compositions of lithium batteries available on the market and can be implemented in a plant which also processes all forms of batteries packs, including metallic and/or plastic casing and support, to limit manual dismantling.

However, further improvements are desired to reduce the operation cost, to increase the yield obtained and to further improve the safety of the recycling processes.

### SUMMARY

In one aspect, there is provided a process of shredding a lithium battery comprising: shredding and quenching the lithium battery with a shredding liquid in a shredding compartment to safely discharge the batteries and producing shredded battery residues and a liquid comprising organic compounds and a lithium compound; separating at least a portion of the liquid from the shredded battery residues to obtain a separated liquid, the separated liquid comprising a low flash point solvent and a high flashpoint solvent; producing a recycled shredding liquid from the separated liquid by removing at least a portion of the low flash point solvent and/or increasing the concentration of the high flashpoint solvent in the recycled shredding liquid to increase a flash point of the recycled shredding liquid compared to a flash point of the shredding liquid in the shredding compartment; and feeding the recycled shredding liquid to the shredding compartment to replace at least a portion of the shredding liquid. In some embodiments, the process further comprises after the shredding and quenching, separating the shredded battery residues and further separating a black mass from the liquid. In some embodiments, the process further comprises separating out an entrained low-flash point solution from the shredded battery residues by drying and/or sink-float operation to increase the concentration of the high flash point solvent and reduce the flammability of the shredded battery residues.

In one aspect, there is provided a process for recycling lithium batteries comprising the steps of: shredding and quenching the lithium batteries with a shredding liquid in a shredding compartment to safely discharge the batteries and producing shredded batteries residues, a black mass and a liquid comprising organic compounds and a lithium compound; separating at least a portion of the liquid from the shredded battery residues to obtain a separated liquid, the separated liquid comprising a low flash point solvent and a high flashpoint solvent; producing a recycled shredding liquid from the separated liquid by removing at least a portion of the low flash point solvent and/or increasing the concentration of the high flashpoint solvent in the recycled shredding liquid to increase a flash point of the recycled shredding liquid compared to a flash point of the shredding liquid in the shredding compartment; feeding the recycled shredding liquid to the shredding compartment to replace at least a portion of the shredding liquid; separating out an entrained low-flash point liquid from the shredded battery residues; separating the shredded battery residues and further separating a black mass from the liquid; mixing the black mass and an acid producing a slurry and leaching the slurry producing a leachate comprising soluble metal ions and non-leachable materials; filtering the leachate to remove the non-leachable materials from the leachate; optionally feeding the leachate into a sulfide precipitation tank removing ionic copper impurities from said leachate; removing iron and aluminum from said leachate; mixing the leachate with a first organic extraction solvent producing an aqueous phase raffinate containing cobalt, nickel and lithium and an organic phase containing manganese; mixing the raffinate with a second organic extraction solvent producing a second aqueous raffinate containing nickel and lithium and an organic phase containing cobalt; increasing the pH of the second aqueous raffinate phase to a pH between 9.5 and 12 to precipitate the nickel from said aqueous phase leaving behind the lithium in aqueous solution; crystallizing sodium sulfate from the aqueous phase containing lithium producing a liquor containing lithium and sodium sulfate crystals; and recovering lithium from the liquor. In some embodiments, the separating out of the entrained low-flash point liquid from the shredded battery residues is performed by drying and/or sink-float operation, and is preferably a sink-float operation.

In some embodiments of the present processes, the process further comprising an addition of a high-flash-point solvent in the sink-float operation to obtain shredded battery residues having a reduced flammability and to improve recovery efficiency of blackmass. In some embodiments, the high flashpoint solvent is selected from an aqueous phase, a glycol or a cyclic carbonate. In some embodiments, the high flashpoint solvent is selected from the group consisting of propylene carbonate (PC), ethylene carbonate (EC), propylene glycol (PG), ethylene glycol (EG), vinylene carbonate (VC), water and combinations thereof. In some embodiments, wherein the step of increasing the concentration of the high flashpoint solvent comprises increasing the relative amount of high flashpoint solvent to low flashpoint solvent in the recycled shredding liquid. In some embodiments, the step of increasing the concentration of the high flashpoint solvent comprises adding to the recycled shredding liquid an amount of the high flashpoint solvent. In some embodiments, the process further comprises removing a portion of the shredding liquid in the shredding compartment and using said portion of the shredding liquid in the step of producing the recycled shredding liquid. In some embodiments, the process further comprises removing a second portion of the shredding liquid in the shredding compartment, producing a second recycled shredding liquid from the second portion of the or shredding liquid by removing at least a portion of the low flash point solvent and increasing the concentration of a second high flashpoint solvent in the second recycled shredding liquid to increase a flash point of the second recycled shredding liquid, and feeding the second recycled shredding liquid to the shredding compartment. In some embodiments, the flashpoint of the recycled shredding liquid is more than 38° C. In some embodiments, the step of shredding and quenching is performed at a temperature of less than 40° C. In some embodiments, the step of removing the low-flash point liquid includes a decantation, a distillation, an activated carbon extraction, a filtration and/or a liquid-liquid extraction. In some embodiments, the step of removing low-flash point solvent is a decantation step that includes the addition of one or more of Na₂SO₄, K₂SO₄, Li₂SO₄, NaCl, NaK-tartrate, Na₃-citrate, Na₂FPO₃, NaH₂PO₄, K₂HPO₄, Na₂S₂O₃, and (NH₄)₂SO₄. In some embodiments, the salt is a sodium sulfate. In some embodiments, the low-flash point liquid includes linear carbonate compounds. In some embodiments, the separate high-flash point solvent is recycled into the recycled shredding liquid. In some embodiments, the shredding liquid comprises a sufficient amount of an aqueous phase to neutralize metallic Li into LiOH. In some embodiments, a level of hydrogen in an offgas from the shredding compartment is used to control the relative feeding amount of battery containing Li metal to the shredding liquid. In some embodiments, a residual hydrogen gas generated from neutralizing Li into LiOH is reused or separated out. In some embodiments, the recycled shredding liquid is cooled to control the temperature of the battery during shredding. In some embodiments, at least 50% of the F present in the shredding liquid is in the form of PF₆. In some embodiments, a selective leaching is performed prior to the leaching step, followed by a magnetic separation step to recover the iron phosphate product separately and producing a lithium-rich stream.

There is provided a black mass obtained by the process of the present disclosure. There is also provided a black mass comprising: Mn, Ni, Co, Li, LiPF₆, a non-leachable fluoride compound, graphite, oxides and inevitable impurities. In some embodiments, the black mass further comprises a humidity comprising linear and cyclic organic solvents and water. In some embodiments, the LiPF₆ is present in the humidity. In some embodiments, the non-leachable fluoride compound is polyvinylidene difluoride (PVDF). In some embodiments, the black mass is free of metallic Li. In some embodiments, the black mass further comprises plastics. In some embodiments, the humidity further comprises glycols and alcohols. In some embodiments, the black mass has a pH above 5. In some embodiments, the black mass includes particles having a mean particle size of more than 50 microns.

Many further features and combinations thereof concerning the present improvements will appear to those skilled in the art following a reading of the instant disclosure.

### BRIEF DESCRIPTION OF THE DRAWINGS

FIG. 1 illustrates schematically the separation steps of the process encompassed herein and in accordance to an embodiment.

FIG. 2 illustrates schematically the electro-mechanical separation steps of the process encompassed herein and in accordance to an embodiment.

FIG. 3 illustrates schematically the hydrometallurgical treatment steps of the process encompassed herein in accordance to an embodiment.

FIG. 4 illustrates schematically the multiple metal separations steps after the solvent extraction step encompassed herein in accordance to an embodiment.

FIG. 5 illustrates a thermogravimetric analysis performed on the black mass obtained according to the present disclosure and a comparative control obtained with a traditional thermal treatment process.

FIG. 6 is a graph showing the particle size distribution of a black mass according to one embodiment of the present disclosure.

### DETAILED DESCRIPTION

The process described herein is designed to be able to handle all cathode compositions of lithium batteries available on the market. The process described herein can be implemented in a plant which can also process all forms of batteries packs, including plastic and/or metal casing and support, to limit manual dismantling. The types of batteries that can be processed or recycled using the process described herein include but are not limited to LFP, LCO, LMO, NMC, NCA, NCMA, LTO and NiMH.

Used batteries entering their end of life can be of different composition. The cathode is usually made of a lithium metal oxide with the metal portion made of a mix of cobalt, nickel and manganese. In some cases, the cathode may include only one or only two of cobalt, nickel and manganese. Other cathode composition such as lithium iron phosphate can also be processed. The anode is often made of graphite or graphite mixed with silicon but can also be composed of metallic lithium. The electrolyte can either be a liquid solvent, usually a mix of an aliphatic carbonate and a cyclic carbonate with a dissolved lithium salt or a solid, such as a lithium based solid electrolyte, a polymer solid electrolyte, or other solid-state electrolyte.

There is provided a process of recycling lithium batteries including a step of shredding the lithium batteries and quenching the lithium batteries and residues with a shredding liquid to safely discharge the batteries in a shredding compartment and producing shredded batteries residues and a liquid comprising organic compounds and a lithium compound. In some embodiments, the shredding compartment can be divided into two consecutive stages of shredding progressively reducing the size of the batteries. The lithium compound can be a salt such as lithium hexafluorophosphate (LiPF₆) or lithium bis(trifluoromethane) sulfonimide (LiTFSi) or can be in a form other than a salt such as any lithium form found in batteries. The most common form of Li in batteries is in the cathode active materials or in the anode in case of Li-metal batteries. In case a battery is charged, lithium initially found in the cathode material will be intercalated in the graphite from the anode and thus can be thought as being similar to metallic lithium. The batteries generally contain one or more solvents selected from dimethyl carbonate (DMC), ethyl methyl carbonate (EMC), diethyl carbonate (DEC), propylene carbonate (PC), ethylene carbonate (EC), and vinylene carbonate (VC). Accordingly, the organic solvent contains linear organic compounds (DMC, EMC, DEC) and cyclic organic compounds (PC, EC and VC). Overtime, for example in a continuous operation, the concentration of cyclic organic solvents can decrease relatively to the concentration of linear organic compounds because the cyclic organic compounds are degraded and/or not recycled back into the shredding compartment. Also, in some cases, an accumulation of solvents, e.g. linear and cyclic organic compounds, can occur overtime. An accumulation of linear organic compounds may lead to a decrease in the flashpoint of the shredding liquid in the shredding compartment which increases the risk of operation.

The present disclosure advantageously recycles a recycled shredding liquid having an increased flashpoint compared to the shredding liquid in the shredding compartment. This allows the overall flashpoint in the shredding liquid to remain above the risk level. In some embodiments, the flashpoint in the shredding liquid in the shredding compartment is maintained above 38° C., preferably above 39° C., more preferably above 40° C. In some embodiments, the recycling described herein may not be continuously operated. The flashpoint of the shredding liquid can be monitored and only when it drops below a predetermined threshold the present recycling process can be performed to increase the flashpoint of the shredding liquid. In some embodiments, the threshold can be below 40° C., below 39° C. or below 38° C.

Other advantages of the present process that will be described in further detail herein below include the reduction in energy intensive heating steps required (e.g. no combustion or pyrolysis at 500° C. or more) and the reduction of associated potential formation of hazardous products, a reduction in the impurities obtained in the black mass, a neutralization of metallic Li and optionally a recovery of the lithium salt.

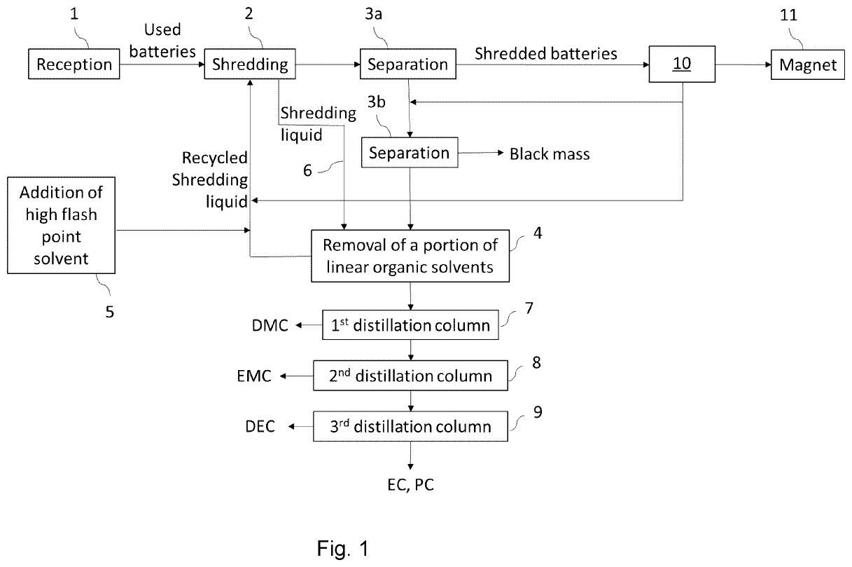

Making reference to FIG. 1, there is provided a process of recycling the shredding liquid to the shredding compartment. The lithium batteries can be received 1 and may or may not have been previously discharged and/or dismantled. Accordingly, in some embodiments, the used batteries have some electrical charge left in them. If the inside components of a charged battery are exposed to the moisture contained in the ambient air, an exothermic reaction occurs which produces hydrogen gas. This incurs a severe risk of combustion of the hydrogen gas and an increased risk of thermal runaway. To minimise the risk of combustion, whole used batteries are shredded 2 under inert atmosphere and under the constant contact with a shredding liquid through quenching to absorb heat from the battery discharging and to neutralized any metallic lithium present in the battery, either from residual charge remaining in the battery or from the presence of metallic lithium for lithium-metal batteries. The quenching can comprise spraying the shredding liquid on the batteries being shredded in the shredding compartment. In some embodiments, the shredding liquid can accumulate in between the two stages of the shredding compartment and continues to wet the partially shredded batteries. Due to the smaller size, the resulting shredded pieces may eventually become fully immersed in the shredding liquid deposited at the bottom of the shredding compartment. However, the quenching is not to be interpreted as an immersion as the whole batteries themselves are not immersed. This shredding liquid is used to dissolve and extract the electrolyte salt contained in the batteries, such as lithium hexafluorophosphate (LiPF₆). The shredding liquid also permits separating black mass (BM) from other solid battery components. The term “black mass” as used herein also refers to a concentrate of strategic materials. The shredding liquid can be miscible with the electrolyte solvent found in batteries cells. Hence, contact between the inside components of the batteries and the oxygen is then limited. Also, in the event of an exothermic reaction, the shredding liquid will serve as a heat sink thus reducing operation hazards. In more severe exothermic conditions, the whole shredding compartment could be filled with shredding liquid and/or water to absorb heat and stop the reaction from progressing. In an embodiment, the shredding liquid is kept under 40° C., in other words the shredding and quenching is performed at a temperature under 40° C., preferably under 30° C., more preferably, even more preferably under 20° C. and in some cases at 10-15° C. In an embodiment, the shredding 2 is performed until an average particle size of about 5 to 15 millimetres is obtained.

Following the shredding 2, the shredded battery residues and the liquid undergo a separation step 3a to separate the liquid phase (i.e. organic solvent with black mass in suspension) from the solid phase (i.e. shredded batteries). The shredded batteries residues can be separated by sieving, filtration, centrifugation or other suitable means. The liquid phase is also subjected to a further separation 3b to obtain a black mass by separating the suspended black mass from the liquid phase.

The shredded battery residues generally contain remaining shredding solvent (i.e. wet shredded batteries) which can have a lower flash point than that of the previously described recycled shredding liquid resulting in battery residue by-products that need to shipped or handled as dangerous goods materials, reducing their value and putting additional cost on the recycling process. The amount of solvent remaining in the battery residues can be controlled via a separation step 10 which can be a sink-float 10 and/or a drying step 10. By adding a high flash point solvent in the sink-float and passing the shredded battery residues in a sink-float operation, not only are the different by-products separated through the difference in their respective specific densities, but the potential flammability of the generated humid by-products, and in particular the light plastic by-product is also greatly reduced. Removal of the entrained solvent from the shredded battery residues increases the ease of handling of the downstream by-products. They are then safer to handle and transport and, in addition, they have higher purity and therefore higher economic value. A secondary benefit of adding a high flash point solvent to the sink float is that the excess solution volume which contains a small portion of the black mass washed from the battery residues is recycled back to the black mass separation step (see arrow in FIG. 1 in between the separations 3a and 3b), thereby increasing overall black mass recovery. In some embodiments, the drying 10 can be performed at a temperature suitable for separating out a specific group of compounds having similar boiling points. For example, low flashpoint solvent can be separated at a temperature of from 60 to 130° C. On the other hand, to separate out high flashpoint solvents temperatures of from 150 to 300° C. can be used. Vacuum drying can also be used to obtain similar separation effect at lower temperature. The same principal can be applied to the drying step to selectively evaporate out and recover the shredding liquid. Similarly, the low-flash point solvents can be extracted and only the high-flash point solvent can be selectively recycled. The shredding liquid recovered from the sink-float and/or drying 10 can then be reused in the separation step 3b or in the shredding step 2. To avoid the melting of light plastics in the oven of the drying step 10, the light plastics can be separated out before heating is applied, for example by a sink/float separation technique, an entrainment of light material like a zig-zag technique or by performing a wet grind and separating out the plastic films that do not get ground by sieving. Accordingly, in some embodiments, both drying and a sink/float are performed at step 10.

The shredding liquid is then subjected to a separation step to remove 4 at least a portion of the lower-flash point solvents for example linear organic solvents. The removal of linear organic solvents increases the flashpoint of the overall mixture since linear organic solvents have low flashpoint temperatures. In some embodiments, the removal 4 can be performed by an activated carbon extraction, a decantation, a liquid-liquid extraction (e.g. organic separation), a filtration and/or a distillation. In preferred embodiments, the removal 4 is performed by an activated carbon extraction, a decantation, and/or a liquid-liquid extraction. Decantation provides a means of separation of higher and lower flash point phases through the difference in their respective densities. This allows for the removal of some low-flash point solution from the circuit, thereby increasing the relative proportion of high flashpoint solvent recycled to the shredding step. It has been found that this separation can be further improved through the addition of a soluble salt, such as Na₂SO₄, K₂SO₄, Li₂SO₄, NaCl, NaK-tartrate, Na₃-citrate, Na₂FPO₃, NaH₂PO₄, K₂HPO₄, Na₂S₂O₃, (NH₄)₂SO₄ or many other soluble salts in the shredding liquid. Information regarding the ionic strength of these salts are described in Hyde, A. M., Zultanski, S. L., Waldman, J. H., Zhong, Y. L., Shevlin, M., & Peng, F. (2017). General principles and strategies for salting-out informed by the Hofmeister series. Organic Process Research & Development, 21 (9), 1355-1370. The increase in ionic strength of the shredding liquid enhances the quantity of low flash point compounds that are removed and transferred to a heavier phase in the decantation equipment which can then be removed from the shredding liquid loop, and replaced with higher flash point solvent. A salt concentration of 5 to 10% was found to be sufficient. As discussed above, the shredding liquid contains different organics, but it was also found to contain LiPF₆. This is because there is sufficient organic in the shredding liquid to solubilise the LiPF₆ within the organic without decomposing it with contact with water. Via ion chromatography, about 75% of the F in the shredding liquid was found to be in the form of LiPF₆. Accordingly, in some embodiments, at least 50%, preferably at least 60%, more preferably at least 70% of the F in the shredding liquid is in the form of LiPF₆. This valuable compound can therefore be optionally recovered, for example by distillation, crystallization and/or precipitation, from the extracted solvent which is eliminated from the circuit in the decantation operation. This further improves the closed loop recycling opportunities of this battery recycling process.

In one embodiment, PC, VC and EC can be regenerated by distillation of the organic solvent and can be separated from linear solvents. EC and/or VC can be separated by converting them to a solid by cooling, and can be re-melted and re-introduced to increase the flashpoint of the shredding liquid as part of the recycled shredding liquid. In some embodiments, PC is preferred over EC because PC remains a liquid under the operating conditions.

The recycled shredding liquid, since it has a higher flashpoint than the shredding liquid, provides the benefit of increasing the flashpoint of the shredding liquid when it is added to the shredding compartment. In some embodiments, the recycled shredding liquid has a flashpoint of at least 39° C., at least 40° C., at least 41° C., at least 42° C., at least 43° C., at least 44° C. or at least 45° C.

Moreover, in some embodiments, it is desirable to control the temperature in the shredding compartment depending on battery discharge, to prevent thermal run-away, and to prevent the formation of fluoro organic gases or other combustion gases. Accordingly, in some embodiments, the recycled shredding liquid can be cooled and sprayed in the shredding compartment to control the temperature of the battery during shredding and limit its reactivity. In some embodiments, a cooling jacket, an external cooling device or similar means can be used to keep the shredding liquid inside the shredding compartment to a temperature below 40° C., for example at 10-15° C.

The shredding liquid can comprise linear organic solvents such as DMC, EMC and DEC which generally have a flash point between 17 and 33° C. These linear organic solvents are referred to herein as low-flashpoint solvents. The shredding liquid can also comprise cyclic organic solvents which have a much higher flashpoint in the range of 65-150° C., preferably 135-150° C. These cyclic organic solvents are referred to herein as high-flash point solvents. The table below summarizes the properties of the 6 main organic solvents found in lithium batteries and consequently in the shredding liquid of the present disclosure together with other organic compounds that can be present in the shredding liquid.

TABLE 1
Properties of compounds

| | | | | Boiling | Melting | |
|---|---|---|---|---|---|---|
| | Solubility | Density | Flashpoint | point | point | ΔvapH° C. |
| ELECTROLYTE | g/L | Kg/m³ | ° C. | ° C. | ° C. | (kJ/kg) |
| (DMC) | 13.9 | 1069 | 17 | 90 | 2 to 4 | 422 |
| (EMC) | Insoluble | 1006 | 23.9 | 107 | −14 | 346 |
| (DEC) | 0.019 | 975 | 33 | 126 | −43 | 358 |
| (EC) | 214 | 1321 | 150 | 243 | 34 to 37 | 690 |
| (PC) | 240 | 1210 | 135 | 242 | −49 | 602 |
| (VC) | 115 | 1350 | 73 | 162 | 22 | 545 |
| Methanol | Soluble | 792 | 12 | 64.7 | −98 | |
| Ethanol | Soluble | 789 | 14 | 78.4 | −114 | |
| Ethylene glycol | Soluble | 1110 | 111 | 197 | −12 | |
| Propylene glycol | Soluble | 1036 | 99-107 | 188 | −59 | |

As can be seen from the table above, increasing the relative concentration of PC, EC and VC with respect to DMC, DEC, and EMC increases the flashpoint of the recycled shredding liquid. PC, VC and EC are particularly advantageous because they are already present in the shredding liquid and can be simply reused into the recycled shredding liquid. However, there are other solvents that can perform the role of increasing the flashpoint (referred to herein as high flashpoint solvents), such solvents may be cyclic carbonate compounds, glycol compounds (e.g. ethylene glycol and propylene glycol), and water. Accordingly in some embodiments, a high flashpoint solvent is added 5 into the recycled shredding liquid to increase its flashpoint. The added high flashpoint solvent may be a compound that is already present in the shredding liquid but is in too low of a concentration (e.g. PC, VC and EC). This addition can be made from an external source and thus may not be considered “recycled” from within the process. In further embodiments, the high flashpoint solvent addition can be recovered from the dryer 10.

Additionally or alternatively other high flash point solvents such as dimethyl sulfoxide (DMSO) and N-methyl pyrrolidone (NMP) can be used to increase the recycled solution flash point. These have the additional advantage of dissolving PVDF binder and enhance the release of graphite and cathode active material which facilitates graphite extraction and separation and therefore also improves leaching kinetics. In some optional embodiments, a portion of the shredding liquid from the shredding compartment can be retrieved from the shredding compartment and subjected to the removal 4 to increase its flashpoint. In some embodiments, the shredding solvent can be subjected to a second separate recycling loop that is independent of the removal 4 step. The second recycling loop has the same steps described above to increase the flashpoint. This second separate recycling loop can also receive additional high flashpoint solvent 5. The second separate recycling loop may in some embodiments replace the above described recycling loop but is preferably optionally performed in addition to it.

In some embodiments, the recycled shredding liquid comprises water. The advantage of the water addition or presence in the recycled shredding liquid is that water can potentially significantly increase the flashpoint. Indeed, water has a strong cooling power (thermal capacity). In addition, the presence of water creates a surface tension of organic-aqueous which can improve cooling. Additional products designed to promote wetting of surface and improve the control of propagation of fires by its increased heat capacity and by promoting formation of spherical miscelles incorporating the flammable solvent may also be incorporated in the recycled shredding liquid. One example of such products is the F500™ encapsulator agent. Water also allows the recovery of metallic Li by solubilizing it (metallic Li reacts with water to form LiOH). In addition, water can decompose LiPF₆ to solubilize Li. This improves the overall Li recovery.

Using current dry method of shredding lithium batteries requires extensive sorting of the lithium batteries prior to shredding in order to separate batteries made with a lithium metal anode. If such a battery was shredded using a dry process, metallic lithium would still be present in the BM after shredding. A subsequent exposition of the BM containing metallic lithium with water or water vapour could initiate localized exothermic reaction of lithium conversion to LiOH which would generate hydrogen gas. This reaction is known to be hazardous. The presence of un-reacted metallic lithium from the shredding of lithium metal batteries is therefore a major source of fire initiation in the traditional recycling industry.

Accordingly, the present process, when performed under inert atmosphere, can be used to shred and neutralize charged batteries or lithium-metal batteries in a single step by providing sufficient amount of water to metallic lithium into the shredding process in order to convert all the metallic lithium into LiOH. The present process thus enables a safe operation during shredding by ensuring proper control of the batteries temperature during shredding and by proper management of the hydrogen gas generated by the neutralization of metallic lithium with the recycled shredding solution. In some embodiments, the level of hydrogen in an offgas of the shredding compartment can be used to control the relative feeding amount of battery containing Li metal to the shredding liquid. An increasing amount of hydrogen increases the risk and would indicate a reduction in entry of batteries containing Li metallic. The hydrogen generated during neutralization is separated using a pressure-swing absorbers or other techniques known to the person skilled in the art. The hydrogen separated may be reused in different applications such as vapour generation or as a source of energy in a gas treatment burner for example.

Li+H₂O→LiOH+½H₂ΔH=−222 kJ/mol

Accordingly, the composition of the recycled shredding liquid in some embodiments comprises DMC, EMC, DEC, EC, PC, VC, LiPF₆, ethylene glycol (EG), propylene glycol (PG), methanol, ethanol and water. In some embodiments, the recycled organic solvent does not comprise glycols such as PG and EG and does not comprise water. In some embodiments, the shredding liquid comprises between 5 and 70 wt. % of cyclic organic compounds, between 0 and 60 wt. % of linear organic compounds and the balance being water. An exemplary composition of the recycled shredding liquid is up to 35 wt. %, up to 40 wt. %, up to 45 wt. %, up to 50 wt. %, up to 55 wt. %, up to 60 wt. %, up to 65 wt. %, up to 70 wt. %, up to 75 wt. % of any combination of DMC, EMC, and DEC, from 5 to 60 wt. %, from 10 to 60 wt. %, from 10 to 50 wt. %, from 15 to 60 wt. %, from 15 to 45 wt. %, from 20 to 45 wt. %, from 25 to 45 wt. %, from 30 to 45 wt. % of PC, VC and/or EC. In some embodiments, the shredding liquid is entirely organic (i.e. free of water) and comprises from up to two thirds of linear organic compounds (e.g. DMC, EMC, and DEC) and one third cyclic organic compounds (e.g. EC, VC and PC) to about half-half. Accordingly, in some embodiments, the ratio of linear organic compounds to cyclic organic compounds is from about 2:1 to about 1:1 by weight. In some embodiments, it may be advantageous to add external EC, VC and/or PC. In some embodiments, a separation technique such as decantation can be used to concentrate, separate or increase the concentration of high flash point solvents such as EC, VC and PC. Accordingly, the recycled shredding liquid can comprise linear organic compounds (DMC, EMC, and/or DEC) and cyclic organic compounds (EC, VC and PC) in a weight ratio of linear to cyclic of at least 1:0.5, at least 1:1, at least 1:2, at least 1:2.5, at least 1:3, at least 1:3.5, and at least 1:4, and in some cases from 0.9:1.1 to 1.1:0.9. In such embodiments, the recycled organic solvent may be free of water or comprise less than 1 wt. % of water.

In some embodiments, the recycled shredding liquid optionally comprises up to 90 wt. % of water. Water may be an addition to the organic solvent described above. In some embodiments, when water is added to the recycled organic solvent (see step 5 of FIG. 1), the recycled shredding liquid can comprise water in a concentration of up to 1 wt. %, up to 5 wt. %, up to 10 wt. %, up to 20 wt. %, up to 30 wt. %, up to 40 wt. %, up to 50 wt. %, up to 60 wt. %, up to 70 wt. %, up to 80 wt. %, up to 85 wt. %, up to 90 wt. %, up to 95 wt. %, up to 98 wt. % or be entirely water.

In some embodiments, the recycled shredding liquid comprises PC in a concentration of from 5 to 95 wt. %, from 10 to 80 wt. %, from 15 to 75 wt. %, from 15 to 60 wt. %, or from 20 to 35 wt. %.

The portion of the shredding liquid that is not recycled back to the shredding compartment can be subjected to one or more distillations to purify the organic solvent. In an embodiment, three distillation columns 7, 8, 9 are used as shown in FIG. 1. The first column 7 can operated at around 90° C. to obtain battery grade dimethyl carbonate (DMC) in the column overhead. The second column 8 can fed with the bottom of the first column, which generally contains ethyl methyl carbonate (EMC), diethyl carbonate (DEC), cyclic carbonates (e.g. EC, VC, PC, or a combination thereof). The second column can be operated at around 107° C. to obtain battery grade ethyl methyl carbonate (EMC) in the column overhead. The second column bottom can fed to the third column 9. The third column can be operated at around 126° C. to obtain battery grade diethyl carbonate (DEC) in the column overhead and EC, VC, PC, or a combination thereof from the column bottom.

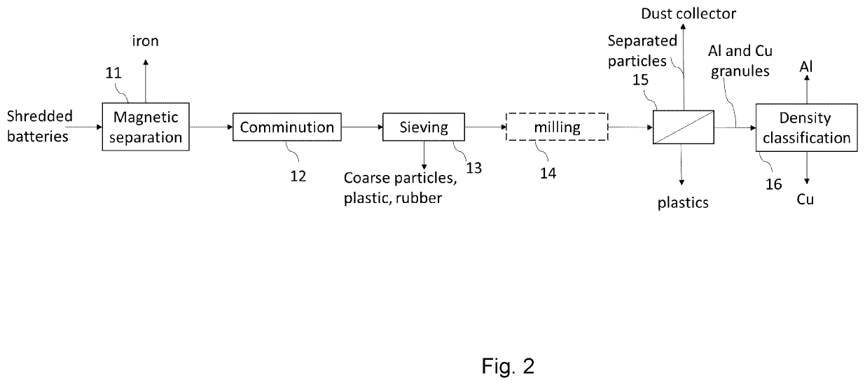

After the sink float and/or the drying 10 the remaining battery residues are fed to a magnetic separator 11 in order to separate iron pieces and particles which are magnetically retained by the magnets, from the other solids. Making reference to FIG. 2, the non-magnetic batteries residues undergo a comminution step 12, or a reduction of the average particle size to a smaller average particle size, e.g. between 0.1 to 4 millimeters. Different crushing and grinding unit operation can be used such as, but not limited to, a hammer mill, an impact crusher, a granulator or a turbo mill. The plastic films, rubbers or other soft products will form the upper range of the particle size distribution. The aluminum is crushed into aluminum in a rounded shape such as spheroids, and the copper foils are reduced in size.

In an embodiment, the outlet from the crusher is then sieved 13 at around 1 millimeter. The oversized fraction is optionally fed to a second milling using an equipment such as, but not limited to, a high shear mixer or a cutting mill for example.

The coarse particles, containing mostly plastics, copper, and aluminum are then fed to a separator 15 where the aluminum and copper granules are extracted. The remaining plastic can be sent to a recycling facility. The aluminum and copper granules may be separated by density classification 16 using an equipment such as, but not limited to, gravimetric separation or an air classifier. The fine particles collected from multiple aspiration points comprises aluminum, copper, other metals and a black powder (graphite+CAM).

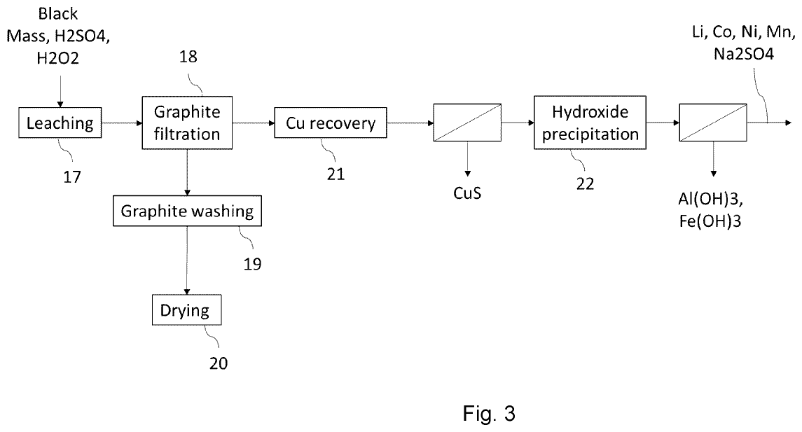

Making reference to FIG. 3, in a leaching tank 17, the black mass is mixed with sulfuric acid and water, to obtain a blackmass slurry with an acidic mass concentration between 5 and 30% in the liquid phase of the slurry, with an operating point around 17%. The slurry is agitated at about 60 to 95° C., for 1 to 4 hours, with a solid concentration between 50 to 250 kg of solids per cubic meters of acid solution. Typical operation should be done at about 60-70° C., for 3 hours, at a solid concentration of 200 kg/m³.

In some embodiments, a selective leaching is performed prior to the leaching step 17. Following the selective leaching a magnetic separation step can be performed to recover the iron phosphate product thereby producing a lithium-rich stream.

A reduction agent may also be added to the reaction tank to help leach transition metals, such as, but not limited to, hydrogen peroxide (H₂O₂), manganese oxide (MnO₂), or aluminum powder (Al), or other reducing elements known in the art. Typical operating concentrations of the reducing agents may vary from 0 to 30% w./w. of solution for the H₂O₂, 0 to 5% w./w. for the MnO₂, and 0 to 5% w./w. for Al. The transition metals in the slurry (Co, Ni, Mn) are reduced, or oxidised, to a divalent (2+) oxidation state, at which they are more readily leachable. Leaching of the metal oxides slurry produces a leachate of metal sulfate which is filtered from solid non leachable materials. In some embodiments, the leaching 17 can be performed in two steps of leaching. In one embodiment, the black mass prior to the first leaching or in between the two leaching steps, is heated to around 550° C. to remove plastic polyvinylidene fluoride (PVDF) and styrene butadiene (SBR), and liberate graphite and cathode active materials (CAM).

In case the leaching is performed in two steps, the graphite cake obtained after the first leaching step (which still contains some valuable black mass) is suspended back in a liquid, for example a liquid similar to the aqueous solution from the leaching step. It is also a mixture of sulfuric acid and a reducing agent such as, but not limited to, hydrogen peroxide (H₂O₂), manganese dioxide (MnO₂), or aluminum powder (Al). This solution solubilises the remaining metals in the graphite. The graphite is then filtered 18 and then washed 19 with water. The graphite cake is then fed into a furnace 20 operating between 200 to 800° C., preferably 600° C., for the remaining plastics, binder and carbon black to be evaporated and the graphite dried. Drying 20 removes humidity and solvents, and can optionally be performed under vacuum or low pressure to prevent solvent reaction or under inert conditions, or under nitrogen or air.

The filtrate, containing the lithium, cobalt, nickel, manganese, iron, aluminum and copper as sulfate salt (Li₂SO₄, CoSO₄, NiSO₄, MnSO₄, Fe₂ (SO₄)₃, Al₂ (SO₄)₃, CuSO₄), is sent for further purification for example by cementation, hydroxide purification, electro winning and the like. Optionally, copper can be recovered 21 by performed by using a sulfide precipitation tank 21 to remove the ionic copper in solution, or it can be directed to a neutralisation/purification stage. Other methods to precipitate or isolate copper such as cementation or ion exchange could also be used. The copper impurities can be precipitated by binding with sulfide ions (S″). The source of sulfide ions can be any sulfide ionic compound such as, but not limited to, sodium sulfide (Na₂S) or bubbling hydrogen sulfide (H₂S). At a pH under 2 and at temperatures between 40 to 80° C., the sulfide will selectively bind to copper to form copper sulfide (CuS) which is insoluble in water. Depending on the concentration of copper ions in solution, concentration of Na₂S may vary between 2 and 5 kg of Na₂S per kg of batteries residues leached, and retention time from 15 min to 1 hour. The precipitate will be eliminated from the main process line by filtration and sold.

CuSO₄+Na₂S+CuS+Na₂SO₄

The leachate is then neutralized 22 to a pH between 3.5 and 5.8 with the addition of sodium hydroxide (NaOH) to precipitate the remaining copper, iron and aluminum, which will form hydroxides (Cu(OH)₂, Al(OH)₃, Fe(OH)₃) that are insoluble in water. The precipitation takes between 30 min to 2 hours to stabilise, with an expected reaction time of 1 hour. The precipitate is filtrated out of the process.

Al₂(SO₄)₃+6NaOH↔2Al(OH)₃+3Na₂SO₄

Fe₂(SO₄)₃+6NaOH=2Fe(OH)₃+3Na₂SO₄

CuSO₄+2NaOH═Cu(OH)₂+Na₂SO₄

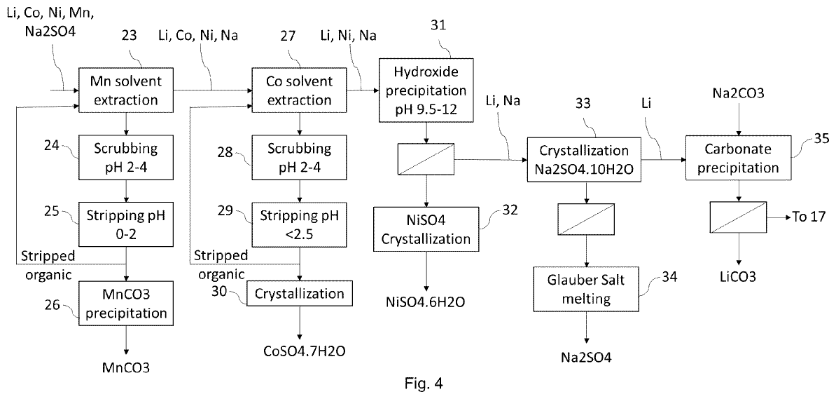

At this point in the process, different routes can be used to separate the Mn, Co and Ni transition metal elements from each other. One route, as shown in FIG. 4, is to perform a solvent extraction step for each of Mn and Co (respectively 23 and 27). Making reference to FIG. 4, the filtrate coming from the hydroxide precipitation stage 22 is sent to a first solvent extraction process for Mn separation 23. The solution is mixed with an organic extraction solvent (extractant) dissolved in a petroleum-based reagent (diluent). The concentration of the extractant in the diluent may vary between 2 and 40 mass percentage, with a more typical value between 15-35%. With the aqueous solution at a pH between 3 to 5, Mn will be extracted by the organic phase, while the cobalt, nickel, and lithium and sodium will remain in the aqueous raffinate phase.

For carrying out the solvent extraction processes, mixer-settlers, extraction columns, such as pulse columns, columns with internal stirring using rotating impellers, reciprocating-plate extraction columns, hollow fiber membrane and the like may be used. For the mentioned equipment, the lighter organic phase is typically pumped out from the top of a settling zone (where there is no more mixing), and the heavier aqueous phase goes out from the bottom of the equipment, through another buffer zone where it is given enough time to separate by decantation. The organic phase is then sent to a scrubbing and stripping stage, and the aqueous phase (raffinate) is sent for further treatment.

In the scrubbing stage 24, the organic phase is contacted with an aqueous solution having a pH about 2 to 4. The two phases are mixed and separated in similar equipment as previously described above. The aqueous solution is returned and mixed with the solvent extraction inlet.

In the stripping stage 25, the Mn-laden organic phase is contacted with an aqueous solution containing sulfuric acid with a pH between 0 and 2 to strip the manganese. Once again, similar equipment as previously described are used here to mix and separate the two phases. Optionally, the process comprises an additional cleaning stage to further regenerate the organic solvent. The cleaned organic solvent is then fed back to the extraction stage. All of the stages are maintained at a temperature between 35° C. and 60° C.

The Mn-rich stripping solution can then be further processed to recover a valuable Mn compound. Different Mn compounds such as MnCO₃, MnO₂, or MnSO₄ can be produced. In the specific case of MnCO₃ a precipitation 26 can be performed. The solution exiting the column is mixed with a carbonate source, such as Na₂CO₃. The precipitated MnCO₃ is then filtered, washed and dried.

Making reference to FIG. 4, the raffinate from the first solvent extraction process, which mainly contains cobalt, nickel and lithium is mixed with a second organic extraction solvent (extractant) dissolved in a petroleum-based reagent (diluent) 27. The process for cobalt solvent extraction is similar to that described previously for manganese, except that the extraction pH range is more typically 3.8 to 5.5, the scrubbing 28 is performed under a pH of 2-4, the stripping 29 is performed under a pH<2.5, and the temperature of all stages is maintained in the 50° C. to 60° C. range.

The Co-rich stripping solution can be further processed to recover a valuable Co compound. One such technique is to process the stripping solution, and in the case where a cobalt sulfate product is desired the solution is sent to a crystalliser 30, and the solid CoSO₄·7H₂O product is then filtered and dried.

However, there are different routes to separate the Mn, Co and Ni transition metal compounds. It is also possible to use a single solvent extraction process for the extraction of both Mn and Co, while leaving Ni in the aqueous raffinate. In such a case, the stripping solution might contain both Co and Mn which would have to be separated from each other. They would be precipitated together if neutralized with sodium hydroxide, but as they have different standard reduction potentials (−0.28 V for cobalt and −1.18 V for manganese), they can be separated by an electrowinning process 26. The cobalt will be plated in its metallic form on the cathode and then scrapped off. Manganese will be oxidized to MnO₂ and deposited on the anode. Cobalt electrowinning is done using an undivided electrolysis cell with cobalt blank cathode and a DSA anode with a current density between 150 and 350 A/m² with a voltage between 2.7 to 5 V. The electrolyte is fed at a pH between 2.5 and 5 at a temperature between 45 and 70° C. The electrode reactions are as follows:

### Cathode:

Co²⁺+2e⁻↔Coₛ

2H⁺+2e⁻↔H₂

### Anode:

H₂O↔½O₂+2H⁺+2e⁻

MnO₂₍ₛ₎+2e⁻+4H⁺↔Mn²⁺+2H₂O

In some embodiments as illustrated in the exemplary FIG. 4, after the solvent extraction steps, the aqueous raffinate contains a large proportion of dissolved nickel sulfate (NiSO₄) from which Ni can be recovered. This can be achieved through different methods such as precipitation, ion exchange or solvent extraction. In one example, a hydroxide precipitation 31 is performed: the solution is heated to between 5° and 70° C., and the pH of the solution is increased to between 9.5 and 12, with an expected value of 10, via the addition of sodium hydroxide 31 to precipitate nickel hydroxide (Ni(OH)₂). The precipitation takes between 0.5. to 4 hours to complete, with an expected reaction time of 3 hours. The nickel hydroxide is filtered, washed, redissolved in a sulfuric acid solution, crystallised 32 at 50° C. as alpha NiSO₄·6H₂O, filtered and dried at 50° C. 28 which can be sold.

At this point in the process, the remaining aqueous solution contains an important proportion of sodium sulfate (Na₂SO₄) and lithium sulfate. The sodium sulfate arises due to the neutralisation of sulfuric acid with sodium hydroxide which happens during the hydroxide precipitation and other steps in the process. The high concentration of sodium sulfate, combined with the important dependency of its solubility to the temperature, makes it appealing for cooling crystallisation including surface cooling, flash-evaporative cooling or other means. By cooling the neutralised leachate between 0° C. and 10° C., a large proportion of the sodium sulfate is crystallised into a decahydrate crystal known as Glauber's salt (Na₂SO₄*10H₂O) 34. Removing sodium sulfate as a hydrated crystal also has the benefit of concentrating the remaining lithium in the aqueous solution (mother liquor). The produced crystals are fed to a centrifuge to be dewatered and washed.

Na₂SO₄+10H₂O↔Na₂SO₄*10H₂O

Glauber Salt can be diluted in water and recrystallised to the anhydrous form if required for further applications or usage.

The sodium sulfate crystal produced will have a high level of purity, due to the numerous purification step upstream. A solution of the purified Na₂SO₄ salt could be amenable to recycling technologies, such as but not limited to electrochemical salt splitting (including electrodialysis, electrolysis etc.) The salt solution could also be submitted to a purification treatment (for example ion exchange) to remove such impurities prior to the electrochemical treatment. The electrolysis of sodium sulfate will produce sulfuric acid and sodium hydroxide, which are the main required consumable reagent of the process. This step will eliminate or reduce the need to feed fresh sulfuric acid and sodium hydroxide to the process.

The mother liquor out of the sodium sulfate crystalliser contains a high concentration of lithium sulfate solution and it is desired to extract the lithium out of the solution. This can be achieved through different methods such as precipitation, crystallization or solvent extraction. In one example, the solution out of the sodium sulfate crystalliser is heated up to a temperature between 80 to 100° C. and a source of carbonate ions (CO₃²⁻) is added to the aqueous solution. The carbonate ion source can be either a carbonate ionic compound such as sodium carbonate (Na₂CO₃), or by bubbling CO₂ gas producing carbonate acid ions (HCO₃⁻) or by a combination of both. The carbonate ions react with lithium ions to produce lithium carbonate (Li₂CO₃) 35, which is only slightly soluble in water. The precipitation is expected to take between 30 min. to 2 hours to stabilise, with an operation retention time of 1 hour. The precipitate is filtered and dried and sold as dried lithium carbonate. The filtrate solution contains lithium and is recycled back in the process, for example to the leaching 17.

Li₂SO₄+CO₃²⁻↔Li₂CO₃+Na₂SO₄

In one aspect of the present disclosure, there is provided a black mass with a reduced impurity and reduced organic contents. In some embodiments, the black mass can be recovered before further reducing the size of shredded residue. In some embodiments, the black mass has a higher proportion of cyclic organic solvent than linear organic solvent compared to the ratio present in batteries (embodiment with recycled organic solvent free of water). In some embodiments, the increased cyclic solvent and/or glycol content confer a higher calorific power to the black mass without providing handling issues of linear solvents.

The black mass filtration generally results in a black mass cake which can be washed to reduce solvent concentration. Humid black mass is recovered and can be optionally dried to a level that maintains humidity sufficiently high to prevent spontaneous reaction with aluminum and water. In some embodiments, a humid black mass (e.g. 30% humidity) is dried to obtain a dried black mass by removing water and light solvents. The drying can for example be a flash drying. The presence of Li and F in the black mass can be in the form of salts such as but not limited to LiTFSi, PO₃F, LIF, LiPF₆, metallic Li, LiOH, LiHCO₃, Li₂CO₃.

The composition of the black mass will vary based on the composition of lithium batteries that were provided at the start of the process. The black mass is obtained from the present process having at least 5 wt. % of humidity which comprises at least linear and cyclic organic solvents and water, Ni, Mn, Co, Li and non-leachable fluoride compound, the balance being graphite, oxides and inevitable impurities. The humidity can be characterized as the presence of solvents including linear and cyclic organic solvents and water, and optionally alcohols and glycols. The major components of the humidity are generally linear and cycluc organic solvents as well as water (taken together being up to 80 wt. % or more). The humidity can for example be present in a concentration of from 5 to 20 wt. %, from 6 to 15 wt. % or from 7 to 10 wt. %. The humidity in the black mass contains or is derived from the shredding liquid of the process. As indicated above and demonstrated in Example 3 below, the shredding liquid contains LiPF₆. This is a valuable compound that is therefore also found in the humidity of the black mass. In some embodiments, LiPF₆ is present in a concentration of from 0.03 to 0.25 wt. % with respect to the total weight of the black mass. In some embodiments, the humidity of the black mass also comprises lithium in the form of LiTFSi. LiTFSi may also be found in the concentration range of from 0.03 to 0.25 wt. %. In some embodiments, the black mass comprises plastics and binder material such as polyvinylidene difluoride (PVDF), which can be considered as inevitable impurities. In some embodiments, a ratio of organic solvent to water in the black mass is higher than 0.05. In some embodiments, the black mass is characterized by having a pH above 5. In some embodiments, the black mass includes or consists of particles having a mean particle size or a D₅₀ of more than 50, more than 60 or more than 100 microns. The black mass can also comprise POF₃ and LiF which can be part of the humidity.

The presence of F in the BM as a non-leachable species (e.g. PVDF) as opposed to leachable species makes the BM less corrosive. This is an advantage of the present process particularly compared to other processes where a thermal treatment or calcination is performed. In such other processes a much larger portion of the F in the BM is leachable. Moreover, in the BM obtained according to the present process, the F can be mostly contained in the graphite. The F present in the graphite is treated under dry conditions and therefore does not present a leachable risk nor a risk of forming HF when contacted with water.

Although the black mass obtained is humid, it can be subjected to a drying step to remove at least a portion of the humidity. In some embodiments, the drying is performed at a temperature that evaporates water and the cyclic organic solvents. In some embodiments, the drying is performed at a temperature that evaporates water, and linear and cyclic organic solvents. The drying temperature can for example be in the range of from 90 to 180° C. When at least a portion or most of the humidity is dried off, the LiPF₆ present in the humidity remains in the black mass and is a valuable material to recover. The concentration of the LiPF₆ in a dried black mass would be relatively higher than in a humid black mass due to the loss of mass of solvents. In some embodiments, the concentration of LiPF₆ in a dried black mass can be from 0.04 to 0.3 wt. %.

### Example 1 Thermogravimetric Analysis (TGA) of Black Mass

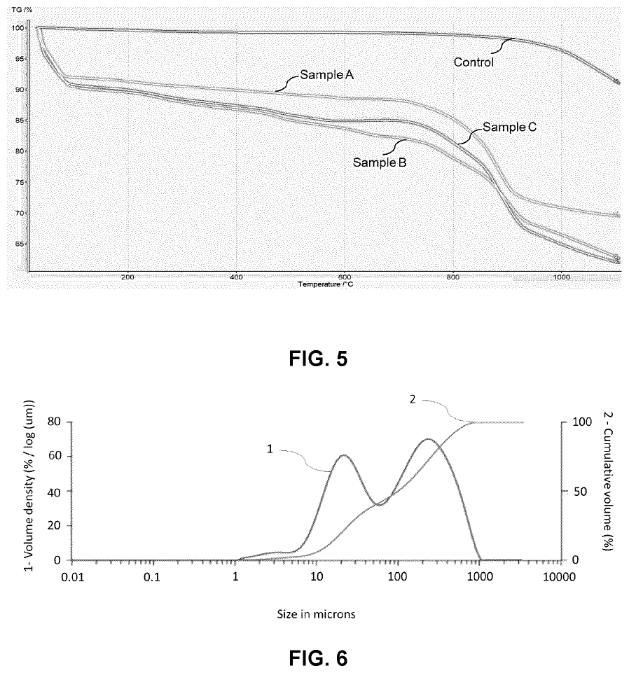

Three black mass samples (labeled samples A, B, and C) and a control black mass sample according to a prior art process which includes pyrolysis were subjected to TGA (FIG. 5) performed under argon. The three samples A-C were obtained with the process according to the present disclosure as described above. The samples will vary in composition depending on the type and composition of batteries received to the recycling plant. The TGA was performed on wet black mass.

TABLE 2
Mass loss during TGA (in weight percent)

| | From 35° C. to | From 105° C. to | | |
|---|---|---|---|---|
| | 105° C. (water | 650° C. (cyclic | From 650° C. to | from 35° C. to |
| | and linear | organics and | 1150° C. | 1150° C. (total |
| | organic solvents) | plastics) | (graphite) | mass loss) |
| Sample A | 8.06 | 3.47 | 19.39 | 30.92 |
| Sample B | 9.54 | 7.68 | 21.86 | 39.08 |
| Sample C | 9.36 | 5.76 | 23.73 | 38.85 |
| Control | 0.21 | 0.63 | 11.04 | 11.88 |

The remaining mass after the mass loss shown in FIG. 5 and Table 2 corresponds to the remaining metals including Ni, Co, and Mn.

### Example 2 Analysis of Battery Residues Before and After Sink-Float Operation

Battery residues obtained by the process of the present disclosure before the step of performing a sink-float operation 10 (see FIG. 1) and after that step were analyzed for their humidity content (Table 3). This shows the level of humidity in the shredded materials (before and after sink-float operation). The risk of flammability can be assessed based on the level of humidity.

TABLE 3
Battery residue analysis before and after sink-float

| | | Dry | |
|---|---|---|---|
| | Humid | mass | % |
| | mass (g) | (g) | humidity |
| 12 mm residues before sink-float | 193.8 | 126.4 | 34.8 |
| Higher density 12 mm residues after | 442.7 | 314.7 | 28.9 |
| sink-float | | | |
| Lower density 12 mm residues after | 187.6 | 63.3 | 66.3 |
| sink-float | | | |
| 20 mm residues before sink-float | 217 | 150 | 30.9 |
| Higher density 20 mm residues after | 319.9 | 234.3 | 26.8 |
| sink-float | | | |
| Lower density 20 mm residues after | 118 | 79.3 | 32.8 |
| sink-float | | | |

### Example 3 Presence of LiPF₆ in the Shredding Liquid

The shredding liquid of the present process as operated according to FIGS. 1-4, was analyzed to determine the different forms of F in the shredding liquid. Quadruplicate experiments of the shredding liquid labeled as 1 to 4 are shown in the Table 4 below. The analysis of the different forms of F as also shown in Table 4.

TABLE 4
F content in the shredding liquid (concentrations in ppm)

| | Shredding | Shredding | Shredding | Shredding |
|---|---|---|---|---|
| Forms of F | liquid 1 | liquid 2 | liquid 3 | liquid 4 |
| F⁻ | 217 | 160 | 149 | 35 |
| FPO₃²⁻ | 2968 | 2640 | 2371 | 2084 |
| PF₆⁻ | 7685 | 8015 | 8017 | 6980 |
| % of PF₆⁻ | 71% | 74% | 76% | 77% |

### Example 4 F Content Released from the BM During Leaching

To assess the non-leachable F content of the BM when not treated with a heat treatment, three BMs were subjected to leaching and the F content was measured (Table 5). It can be seen from Table 5 that in the absence of a heat treatment the F species remain mostly in non-leachable form (e.g. PVDF) and remain in the graphite. This is therefore a much safer operation and removal of F.

TABLE 5
F content in BM leaching

| | BM | | | | |
|---|---|---|---|---|---|
| | Fluorine in | Fluorine in leachate | | Fluorine in | |
| | blackmass | solution | | graphite | |
| | before | Single | Dual | Single | Dual |
| | leaching | leach | leach | leach | leach |
| Heat treatment | (mg/l) | (mg/l) | (mg/l) | (mg/l) | (mg/l) |
| none | 14428 | 357 | 524 | 28807 | 30500 |
| air, 500° C. | 14389 | 2195 | 2161 | 174 | 79 |
| N₂, 500° C. | 15718 | 1332 | 2881 | 206 | 90 |

### Example 5 Recycled Solution Obtained from Decantation Process with and without Salt Addition

An example of a shredding solution was prepared by mixing 40 wt. % of an electrolyte collected from lithium-ion batteries with 60 wt. % of an aqueous solution. The analysis of the electrolyte before mixing gave the following concentration of low flash-point solvents and high-flash-point solvents.

TABLE 6
Initial electrolyte solution composition in wt. %

| | |
|---|---|
| DMC | 33.16 |
| EMC | 22.13 |
| DEC | 0.42 |
| EC | 26.76 |
| Linear to cyclic | 2.1 |
| ratio | |

The prepared solution was fed to a decantation unit and the performance was investigated with the addition of pure water in a first case and with a 10 wt. % Na₂SO₄ solution. The separated heavy fraction in both cases contained a higher ratio of low flash-point solvent (linear solvents DMC, EMC, DEC) to high flash-point solvents (cyclic solvent EC) compared to the ratio in the incoming electrolyte solution showing that the decantation is efficient in removing more of the low flash point solvent and producing a recycled shredding liquid (light fraction A) containing a lower amount of low flash-point solvents compared to the original mix.

Moreover, the addition of a 10 wt. % Na₂SO₄ aqueous solution instead of pure water to the example solution resulted in a recycled shredding liquid (light fraction B) with a ratio of linear to cyclic lower when compared to pure water (light fraction A) thus resulting in a higher flash-point for the solution with the addition of the salt.

TABLE 7
Results for the heavy and light fractions

| | | | Heavy | Light |
|---|---|---|---|---|
| | | | phase with | phase with |
| | Heavy | Light | Na₂SO₄ | Na₂SO₄ |
| | phase with | phase with | solution | solution |
| | water (A) | water (A) | (B) | (B) |
| DMC | 34.86 | 7.66 | 30.96 | 5.69 |
| EMC | 33.07 | 4.09 | 25.32 | 2.6 |
| DEC | 0.65 | 0.15 | 0.45 | 0.13 |
| EC | 14.21 | 8.67 | 17.2 | 7.6 |
| Water and others | 17.21 | 79.43 | 26.07 | 83.98 |
| Linear to cyclic | 4.8 | 1.4 | 3.3 | 1.1 |
| ratio | | | | |

### Example 6 Black Mass Particle Size Distribution

A black mass as obtained according to the present disclosure (i.e. without any further heat treatments) was analyzed for its particle size distribution. A D₅₀ of about 100 μm was determined (FIG. 6).

The embodiments described in this document provide non-limiting examples of possible implementations of the present technology. Upon review of the present disclosure, a person of ordinary skilled in the art will recognize that changes may be made to the embodiments described herein without departing from the scope of the present technology. Yet further modifications could be implemented by a person of ordinary skill in the art in view of the present disclosure, which modifications would be within the scope of the present technology.

1. A process of shredding a lithium battery comprising:
shredding and quenching the lithium battery with a shredding liquid in a shredding compartment to safely discharge the batteries and producing shredded battery residues and a liquid comprising organic compounds and a lithium compound;
separating at least a portion of the liquid from the shredded battery residues to obtain a separated liquid, the separated liquid comprising a low flash point solvent and a high flashpoint solvent;
producing a recycled shredding liquid from the separated liquid by removing at least a portion of the low flash point solvent and/or increasing the concentration of the high flashpoint solvent in the recycled shredding liquid to increase a flash point of the recycled shredding liquid compared to a flash point of the shredding liquid in the shredding compartment; and
feeding the recycled shredding liquid to the shredding compartment to replace at least a portion of the shredding liquid.

2. The process of claim 1, further comprising after the shredding and quenching, separating the shredded battery residues and further separating a black mass from the liquid.

3. The process of claim 1, further comprising separating out an entrained low-flash point solution from the shredded battery residues by drying and/or sink-float operation to increase the concentration of the high flash point solvent and reduce the flammability of the shredded battery residues.

4. A process for recycling lithium batteries comprising the steps of:
shredding and quenching the lithium batteries with a shredding liquid in a shredding compartment to safely discharge the batteries and producing shredded batteries residues, a black mass and a liquid comprising organic compounds and a lithium compound;
separating at least a portion of the liquid from the shredded battery residues to obtain a separated liquid, the separated liquid comprising a low flash point solvent and a high flashpoint solvent;
producing a recycled shredding liquid from the separated liquid by removing at least a portion of the low flash point solvent and/or increasing the concentration of the high flashpoint solvent in the recycled shredding liquid to increase a flash point of the recycled shredding liquid compared to a flash point of the shredding liquid in the shredding compartment;
feeding the recycled shredding liquid to the shredding compartment to replace at least a portion of the shredding liquid;
separating out an entrained low-flash point liquid from the shredded battery residues;
separating the shredded battery residues and further separating a black mass from the liquid;
mixing the black mass and an acid producing a slurry and leaching the slurry producing a leachate comprising soluble metal ions and non-leachable materials;
filtering the leachate to remove the non-leachable materials from the leachate;
optionally feeding the leachate into a sulfide precipitation tank removing ionic copper impurities from said leachate;
removing iron and aluminum from said leachate;
mixing the leachate with a first organic extraction solvent producing an aqueous phase raffinate containing cobalt, nickel and lithium and an organic phase containing manganese;
mixing the raffinate with a second organic extraction solvent producing a second aqueous raffinate containing nickel and lithium and an organic phase containing cobalt;
increasing the pH of the second aqueous raffinate phase to a pH between 9.5 and 12 to precipitate the nickel from said aqueous phase leaving behind the lithium in aqueous solution;
crystallizing sodium sulfate from the aqueous phase containing lithium producing a liquor containing lithium and sodium sulfate crystals; and
recovering lithium from the liquor.

5. The process of claim 4, wherein the separating out of the entrained low-flash point liquid from the shredded battery residues is performed by drying and/or sink-float operation, and is preferably a sink-float operation.

6. The process of claim 3, further comprising an addition of a high-flash-point solvent in the sink-float operation to obtain shredded battery residues having a reduced flammability and to improve recovery efficiency of blackmass.

7. The process of claim 1, wherein the high flashpoint solvent is selected from an aqueous phase, a glycol or a cyclic carbonate.

8. The process of claim 7, wherein the high flashpoint solvent is selected from the group consisting of propylene carbonate (PC), ethylene carbonate (EC), propylene glycol (PG), ethylene glycol (EG), vinylene carbonate (VC), dimethyl sulfoxide (DMSO), N-methyl pyrrolidone (NMP), water and combinations thereof.

9. The process of claim 1, wherein the step of increasing the concentration of the high flashpoint solvent comprises increasing the relative amount of high flashpoint solvent to low flashpoint solvent in the recycled shredding liquid, or wherein the step of increasing the concentration of the high flashpoint solvent comprises adding to the recycled shredding liquid an amount of the high flashpoint solvent.

10. (canceled)

11. The process of claim 1, further comprising removing a portion of the shredding liquid in the shredding compartment and using said portion of the shredding liquid in the step of producing the recycled shredding liquid.

12. The process of claim 1, further comprising removing a second portion of the shredding liquid in the shredding compartment, producing a second recycled shredding liquid from the second portion of the shredding liquid by removing at least a portion of the low flash point solvent and/or increasing the concentration of a second high flashpoint solvent in the second recycled shredding liquid to increase a flash point of the second recycled shredding liquid, and feeding the second recycled shredding liquid to the shredding compartment.

13-14. (canceled)

15. The process of claim 1, wherein the step of removing the low-flash point liquid includes a decantation, a distillation, an activated carbon extraction, a filtration and/or a liquid-liquid extraction.

16. The process of claim 15, wherein the step of removing low-flash point solvent is a decantation step that includes the addition of one or more of Na2SO4, K2SO4, Li2SO4, NaCl, NaK-tartrate, Na3-citrate, Na2FPO3, NaH2PO4, K2HPO4, Na2S2O3, and (NH4)2SO4.

17. (canceled)

18. The process of claim 1, wherein the low-flash point liquid includes linear carbonate compounds.

19. (canceled)

20. The process of claim 1, wherein the shredding liquid comprises a sufficient amount of an aqueous phase to neutralize metallic Li into LiOH.

21.-23. (canceled)

24. The process of claim 1, wherein at least 50% of the F present in the shredding liquid is in the form of PF6.

25. (canceled)

26. A black mass obtained by the process of any one of claims 1 to 25.

27. The black mass of claim 26 comprising: Mn, Ni, Co, Li, LiPF6, a non-leachable fluoride compound, graphite, oxides and inevitable impurities.

28. The black mass of claim 27, further comprising a humidity comprising linear and cyclic organic solvents and water, wherein the LiPF6 is present in the humidity.

29-30. (canceled)

31. The black mass of claim 27, wherein the black mass is free of metallic Li.

32-35. (canceled)
